(19) United States
(12) Patent Application Publication
(10) Pub. No.: US 2023/0116682 A1
(43) Pub. Date: Apr. 13, 2023

(54) Multiple Interface External Hard Drive Apparatus

(71) Applicants: Tigris Clemons, Frisco, TX (US); Michael Thurman, Frisco, TX (US)

(72) Inventors: Tigris Clemons, Frisco, TX (US); Michael Thurman, Frisco, TX (US)

(21) Appl. No.: 17/488,794

(22) Filed: Sep. 29, 2021

(51) Int. Cl. G06F 1/3234; G06F 13/42; H04W 4/80

(52) U.S. Cl. CPC G06F 1/3268; G06F 1/3275; G06F 13/4282; H04W 4/80

(57) ABSTRACT

A multiple interface external hard drive apparatus for easily backing up data and preventing overheating includes a battery coupled within a case. A charge port is coupled to the case and is in operational communication with the battery. A circuit board is coupled within the case and is in operational communication with the battery. A plurality of memory storage chips is coupled to the circuit board. A processor chip, a processor memory chip, and a wireless transceiver are coupled to the circuit board and are in operational communication with the plurality of memory storage chips. A plurality of ports is coupled to the case top side and is in operational communication with the processor chip. A touch screen display is coupled to the case front side and is in operational communication with the processor chip.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to external hard drive devices and more particularly pertains to a new external hard drive device for easily backing up data and preventing overheating. The present device includes a plurality of individually retractable port connectors rather than traditional cable ports. The device also includes wireless and touchscreen interfaces.

### Description of Related Art Including Information Disclosed Under 37 CFR 1.97 and 1.98

The prior art relates to external hard drive devices. Known devices typically include cable ports and cables that become unreliable with time. Some devices also include a single connector which may be selectively covered but not retracted. Present devices also lack direct interfaces such as touchscreens.

### BRIEF SUMMARY OF THE INVENTION

An embodiment of the disclosure meets the needs presented above by generally comprising a case having a case front side, a case back side, a case top side, a case bottom side, a case left side, and a case right side. A battery is coupled within the case. A charge port is coupled to the case and is in operational communication with the battery and configured to receive a charge cable. A circuit board is coupled within the case and is in operational communication with the battery. A plurality of memory storage chips is coupled to the circuit board. A processor chip is coupled to the circuit board and is in operational communication with the plurality of memory storage chips. A processor memory chip is coupled to the circuit board and is in operational communication with the processor chip. A wireless transceiver is coupled to the circuit board and is in operational communication with the processor chip and is configured to be in wireless communication with a personal electronic device. A plurality of ports is coupled to the case. The plurality of ports is coupled to the case top side and is in operational communication with the processor chip. A touch screen display is coupled to the case. The touch screen display is coupled to the case front side and is in operational communication with the processor chip. A power button is coupled to the case. The power button is coupled to the case front side and is in operational communication with the processor chip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an isometric view of a multiple interface external hard drive apparatus according to an embodiment of the disclosure.

FIG. 2 is a top plan view of an embodiment of the disclosure.

FIG. 3 is a front elevation view of an embodiment of the disclosure.

FIG. 4 is a rear elevation view of an embodiment of the disclosure.

FIG. 5 is a side elevation view of an embodiment of the disclosure.

FIG. 6 is a bottom plan view of an embodiment of the disclosure.

### DETAILED DESCRIPTION OF THE INVENTION

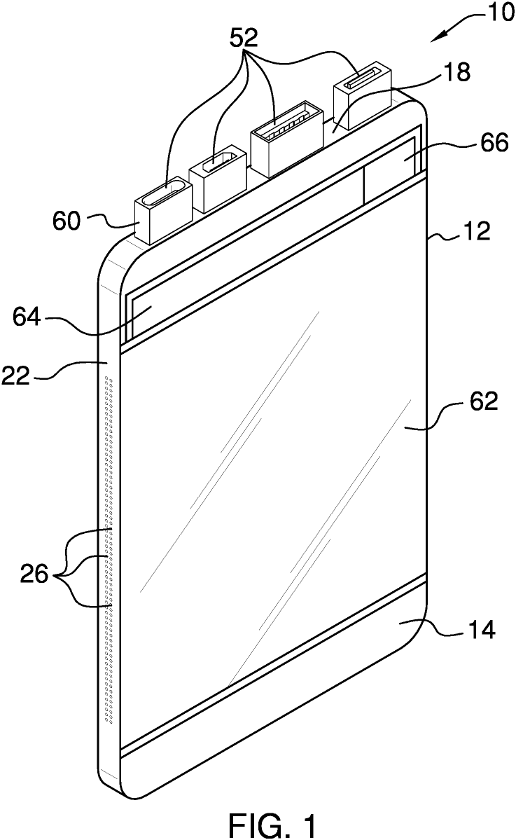

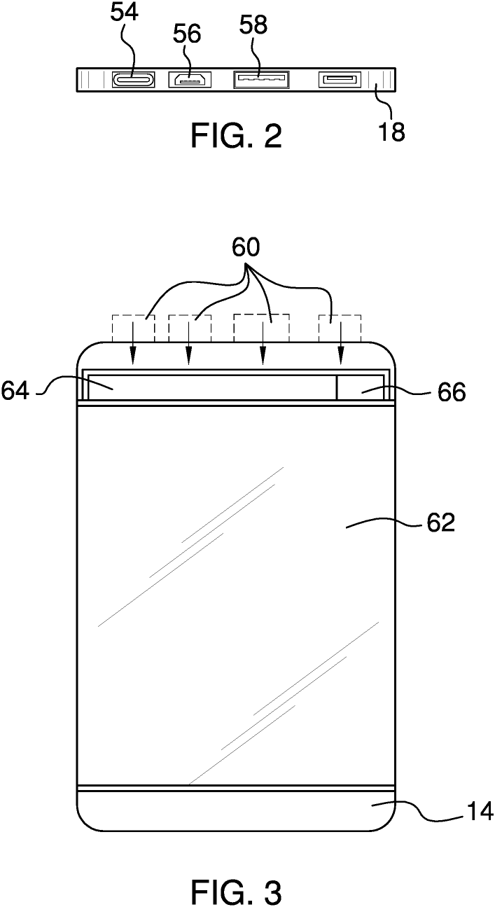

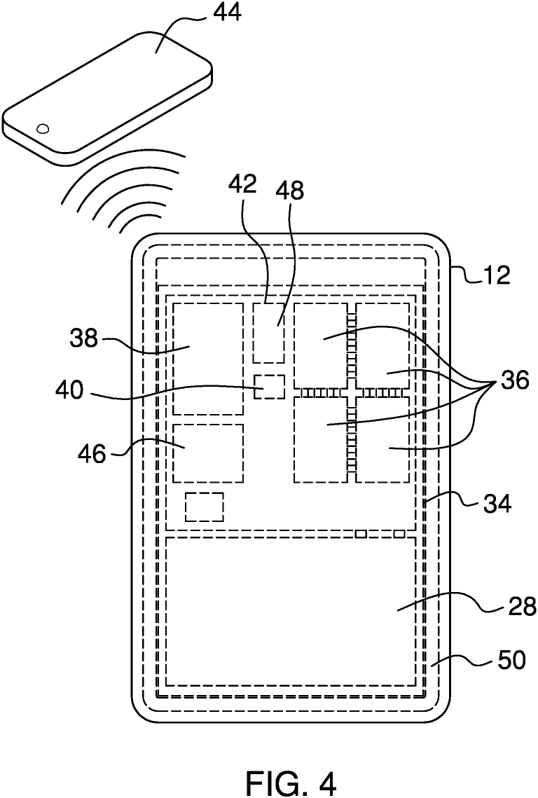

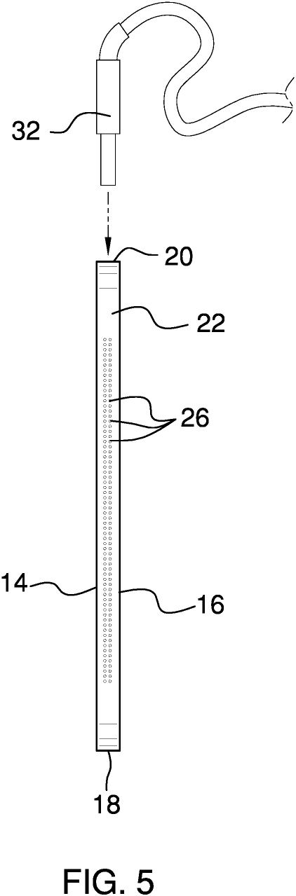

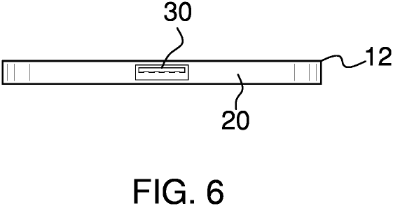

With reference now to the drawings, and in particular to FIGS. 1 through 6 thereof, a new external hard drive device embodying the principles and concepts of an embodiment of the disclosure and generally designated by the reference numeral 10 will be described.

As best illustrated in FIGS. 1 through 6, the multiple interface external hard drive apparatus 10 generally comprises a case 12 having a case front side 14, a case back side 16, a case top side 18, a case bottom side 20, a case left side 22, and a case right side 24. The case left side 22 and the case right side 24 may have a plurality of vent apertures 26. The case 12 may be dimensioned to conform to the shape of a standard credit card at 86 mm by 56 mm. The case 12 may be an alloy including nickel, chromium, magnesium, or molybdenum. A battery 28 is coupled within the case 12.

A charge port 30 is coupled to the case 12. The charge port 30 is in operational communication with the battery 28 and is configured to receive a charge cable 32. The charge port 30 may extend through the case bottom side 20. A circuit board 34 is coupled within the case 12. The circuit board 34 is in operational communication with the battery 28. A plurality of memory storage chips 36 is coupled to the circuit board 34. The plurality of memory storage chips 36 function as a solid state drive (SSD) to store at least 256 gigabytes of data.

A processor chip 38 is coupled to the circuit board 34. The processor chip 38 is in operational communication with the plurality of memory storage chips 36. A processor memory chip 40 is coupled to the circuit board 34 and is in operational communication with the processor chip 38. The processor chip 38 and the processor memory chip 40 run an operating system capable of having a lock screen with password, maintaining time and date, a visual representation of files stored on the plurality of memory storage chips 36, and a settings page. The device 10 may be set up such that a specific operating system to be used may be selected upon activation of the device 10.

A wireless transceiver 42 is coupled to the circuit board 34. The wireless transceiver 42 is in operational communication with the processor chip 38 and is configured to be in wireless communication with a personal electronic device 44. The wireless transceiver 42 may include a Bluetooth/Wi-Fi chip 46 and a near-field communication (NFC) chip 48.

A shock barrier 50 is coupled within the case 12. The shock barrier 50 surrounds the circuit board 34 to protect the plurality of memory storage chips 36, the processor chip 38, the processor memory chip 40, and the wireless transceiver 42. The shock barrier 50 may be comprised of multiple layers including, but not limited to, viscoelastic urethane polymer, polyester film, water resistant coating, and aerogel. The shock barrier 50 inhibits overheating resulting in reduced issues with freezing or crashing. In addition, the shock barrier 50 prevents water and dirt from damaging the circuit board 34.

A plurality of ports 52 is coupled to the case 12. The plurality of ports 52 may be coupled to the case top side 18 and is in operational communication with the processor chip 38. The plurality of ports 52 may include a lightning port 54, a micro-b port 56, and a universal serial bus (USB) port 58. Each port of the plurality of ports 52 may have a rectangular prismatic port case 60 retractably coupled to the case top side 18. Each port case 60 moves between a retracted position flush with the case top side 18 shown in FIG. 3 and an extended position shown in FIG. 1. Each port case 60 may be springloaded.

A touch screen display 62 may be coupled to the case 12. The touch screen display 62 is coupled to the case front side 14 and is in operational communication with the processor chip 38 to interface with the operating system. There may be a touch scroll bar 64 coupled to the case front side 14 adjacent the touch screen display 62 and in operational communication with the touch screen display 62 to serve as an addition interface. A power button 66 is coupled to the case 12. The power button 66 is coupled to the case front side 14 and is in operational communication with the processor chip 38. The device 10 may be set up such that a specific operating system to be used may be selected by interaction through the touch screen display 62 upon activation of the device 10.

In use, the desired port of the plurality of ports 52 is pressed to release the port case 60 to the extended position. The appropriate cable may then be used to interface with the personal electronic device 44. The wireless transceiver 42 may alternatively be used to transfer files between the apparatus 10 and the personal electronic device 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multiple interface external hard drive apparatus comprising:
a case having a case front side, a case back side, a case top side, a case bottom side, a case left side, and a case right side;
a battery coupled within the case;
a charge port coupled to the case, the charge port being in operational communication with the battery and configured to receive a charge cable;
a circuit board coupled within the case, the circuit board being in operational communication with the battery;
a plurality of memory storage chips coupled to the circuit board;
a processor chip coupled to the circuit board, the processor chip being in operational communication with the plurality of memory storage chips;
a processor memory chip coupled to the circuit board, the processor memory chip being in operational communication with the processor chip;
a wireless transceiver coupled to the circuit board, the wireless transceiver being in operational communication with the processor chip and being configured to be in wireless communication with a personal electronic device;
a plurality of ports coupled to the case, the plurality of ports being coupled to the case top side and being in operational communication with the processor chip;
a touch screen display coupled to the case, the touch screen display being coupled to the case front side and being in operational communication with the processor chip; and
a power button coupled to the case, the power button being coupled to the case front side and being in operational communication with the processor chip.

2. The multiple interface external hard drive apparatus of claim 1 further comprising the case left side and the case right side having a plurality of vent apertures.

3. The multiple interface external hard drive apparatus of claim 1 further comprising a touch scroll bar coupled to the case, the touch scroll bar being coupled to the case front side adjacent the touch screen display and being in operational communication with the touch screen display.

4. The multiple interface external hard drive apparatus of claim 1 further comprising the plurality of ports including a lightning port, a micro-b port, and a universal serial bus (USB) port.

5. The multiple interface external hard drive apparatus of claim 1 further comprising each port of the plurality of ports having a rectangular prismatic port case retractably coupled to the case top side, each port case moving between a retracted position flush with the case top side and an extended position.

6. The multiple interface external hard drive apparatus of claim 5 further comprising each port case being spring-loaded.

7. The multiple interface external hard drive apparatus of claim 1 further comprising the wireless transceiver including a Bluetooth/Wi-Fi chip.

8. The multiple interface external hard drive apparatus of claim 7 further comprising the wireless transceiver including a near-field communication (NFC) chip.

9. The multiple interface external hard drive apparatus of claim 1 further comprising a shock barrier coupled within the case, the shock barrier surrounding the circuit board.

10. A multiple interface external hard drive apparatus comprising:
a case having a case front side, a case back side, a case top side, a case bottom side, a case left side, and a case right side, the case left side and the case right side having a plurality of vent apertures;
a battery coupled within the case;
a charge port coupled to the case, the charge port being in operational communication with the battery and configured to receive a charge cable;
a circuit board coupled within the case, the circuit board being in operational communication with the battery;
a plurality of memory storage chips coupled to the circuit board;
a processor chip coupled to the circuit board, the processor chip being in operational communication with the plurality of memory storage chips;
a processor memory chip coupled to the circuit board, the processor memory chip being in operational communication with the processor chip;
a wireless transceiver coupled to the circuit board, the wireless transceiver being in operational communication with the processor chip and being configured to be in wireless communication with a personal electronic device, the wireless transceiver including a Bluetooth/Wi-Fi chip and a near-field communication (NFC) chip;
a shock barrier coupled within the case, the shock barrier surrounding the circuit board;
a plurality of ports coupled to the case, the plurality of ports being coupled to the case top side and being in operational communication with the processor chip, the plurality of ports including a lightning port, a micro-b port, and a universal serial bus (USB) port, each port of the plurality of ports having a rectangular prismatic port case retractably coupled to the case top side, each port case moving between a retracted position flush with the case top side and an extended position, each port case being spring-loaded;
a touch screen display coupled to the case, the touch screen display being coupled to the case front side and being in operational communication with the processor chip;
a touch scroll bar coupled to the case, the touch scroll bar being coupled to the case front side adjacent the touch screen display and being in operational communication with the touch screen display; and
a power button coupled to the case, the power button being coupled to the case front side and being in operational communication with the processor chip.
